(19) United States
(12) Patent Application Publication
(10) Pub. No.: US 2012/0237690 A1
(43) Pub. Date: Sep. 20, 2012

(54) Continuous Powder Coating Method for Profiles Having Little or No Conductivity

(75) Inventor: Kevin Stay, West Salem, WI (US)

(73) Assignee: Mathew A. McPherson, Norwalk, WI (US)

(21) Appl. No.: 13/050,121

(22) Filed: Mar. 17, 2011

(51) Int. Cl. B05D 1/04; B05D 1/36; B05D 1/38; B05D 1/22; B05D 1/02; B05D 1/30; B05D 1/18; B05D 3/02; B05D 1/00; B05D 3/00

(52) U.S. Cl. 427/459; 427/466

(57) ABSTRACT

A process for applying an electrostatic coating to a profile in-line, the method including the steps of forming a profile, applying a primer composition to the profile, the primer composition including at least one halogen, halogen salt, halogen complex or mixture thereof and at least one carrier and electrostatically applying a coating composition while the primer composition is wet.

### FIELD OF THE INVENTION

The present invention relates to a process of electrostatically painting substrates, particularly to a process of electrostatically painting substrates in-line, and to articles made thereby.

### BACKGROUND OF THE INVENTION

The use of electrostatic powder coating techniques to paint electrically conductive substrates, such as metals, is well known and successfully employed. Using this method, a powder coating material is statically charged or ionized to a positive polarity or negative polarity, and then sprayed or blown onto a grounded, conductive article to which it adheres. The electrostatic attraction between the paint and the grounded article results in a more efficient painting process with less wasted material, and a thicker, more consistent paint coverage, particularly on articles that have a complex shape. Once coated, the article is then baked. In electrostatic painting, a powder coating material is statically charged and applied using standard powder coating equipment. With electrically conductive substrates, a static electric potential is generated between the paint and the substrate to be painted resulting in an attraction of the paint to the object.

When articles fabricated from metals are painted, the metal, which is inherently conductive, is easily grounded and efficiently painted.

However, in recent years, there has been an emphasis on the use of substrates having little or no conductivity such as polymeric materials in the manufacture of articles, particularly in applications requiring reductions in weight and improved corrosion resistance, such as for automotive applications. However, polymers typically used in such processes are insufficiently conductive to efficiently obtain satisfactory paint thickness and coverage when the article is electrostatically painted.

On poor electrical conductors such as polymeric materials and poor metals or metalloids, the conventional electrostatic coating techniques are not as successful because an electric charge potential must exist between both the substrate and the paint. If an object has poor electrical conductivity, it cannot be efficiently electrostatically charged and cannot, therefore, be efficiently electrostatically painted. Furthermore, on surfaces with little or no conductivity, low humidity levels can have a negative impact on the quality of the bond of the powder coating to the surface.

Even so, electrostatic painting techniques are still desirable for use due to the benefits, especially for large scale commercial operations, including less loss of paint than with the use of other painting techniques such as spraying a liquid paint, and the quality of the coating is quite good because the method allows for a uniform distribution of paint without the entire surface being easily accessible.

It is difficult to get an electrostatically applied paint to tenaciously adhere to substrates which have little or no conductivity such as substrates formed from organic-based composite materials or from fiberglass filled composites. Materials having little or no conductivity such as polymers, may first be coated with a conductive primer or “prep” coating, and then electrostatically painted. Thus, it is known in the industry to first apply a conductive primer coating to a non-conductive substrate prior to electrostatically coating the substrate. This helps to ensure a more uniform and tenaciously adhered top coating of paint.

However, depending on the particular primer employed, the cured primer may have adhesion, surface smoothness, hydrolytic stability, and durability characteristics, which are less than desirable for a particular application. Additionally, such primers compositions may contain volatile organic solvents, the emission of which during the priming process may be undesirable, as well as environmentally unfriendly. Further, each of the treatments described above can be expensive.

Furthermore, it has heretofore been difficult to apply the primer composition and electrostatically paint substrates having little or no conductivity inline in an efficient and economical manner, and with little or no volatile organic compounds (VOC's).

All published documents, including all U.S. patent documents, mentioned anywhere in this application are hereby expressly incorporated herein by reference in their entirety. Any copending patent applications, mentioned anywhere in this application are also hereby expressly incorporated herein by reference in their entirety.

### SUMMARY OF THE INVENTION

The present invention relates to an improved process wherein profiles formed through extrusion/pultrusion processes can be electrostatically coated in-line efficiently and economically, resulting in a tenaciously adhered coating.

The method according to the present invention, although not limited to such substrates, is particularly effective for electrostatically coating pultrusion/extrusion profiles which are formed of materials which have little or no conductivity such as organic materials and composites thereof, fibers and composites thereof and poor metals or metalloids and alloys thereof which are typically poor conductors. The process according to the present invention is not limited to such substrates, however, and can in fact be employed for any pultrusion/extrusion profile regardless of the material from which it is formed.

In one aspect, the present invention relates to a process for applying an electrostatic coating to a profile formed via extrusion or pultrusion in-line, the method including the steps of forming a profile, applying a primer composition to the profile, the primer composition comprising at least one halogen, halogen salt, halogen complex or mixture thereof and at least one carrier liquid, and electrostatically applying a coating composition.

The coating composition may be applied while the primer composition is still wet. As previous processes required drying, the present invention streamlines the processing and improves the efficiency of making and coating profiles formed via extrusion or pultrusion. As used herein, the term “halogen complex” shall include halophors (typically a complex of a halogen and certain types of surface-active agents) or any carrier of a halogen.

In another embodiment, the present invention relates to a process of forming a fiber reinforced profile including the steps of providing a fiber source, applying a resin composition to the fiber source to form a composite, applying a heat source to the composite, pultruding the composite through a die using pullers to form a profile, applying a primer composition to the profile, and electrostatically coating the profile. Further steps may include outgasing prior to application of the primer composition, baking the profile after application of the electrostatic coating, and cutting the profile into a final form. Outgasing may be accomplished by preheating the profile prior to application of the primer composition.

The primer composition may be applied to a portion of, or all of the profile. The present invention allows for selectively coating/painting of the profile.

The primer composition suitably includes at least one halogen, halogen salt, halogen complex or mixture thereof in a carrier liquid. In one aspect of the invention, the primer composition includes at least one iodophor. In specific embodiments, the primer composition includes a mixtures of iodophors, for example, one iodophor of polyethoxylated fatty alcohol and one iodophor of polyethoxylated nonylphenol.

In one aspect, the method of the present invention is employed to electrostatically paint profiles in-line which are formed of fiberglass composites wherein a composition including at least one thermoplastic material, at least one thermoset material or mixture thereof is applied to the glass fibers. In some embodiments, a resin bath is employed to apply the thermoplastic or thermoset composition. In one specific embodiment, the profile is formed from a composite of fiberglass and a thermoset material which has been applied to the fiberglass in an uncured state, and then subsequently cured. Suitably, the fiberglass composites are formed using pultrusion techniques.

In one aspect the present invention is employed to electrostatically paint profiles in-line which are formed from aluminum, a poor metal, or vinyl

The present invention is advantageous in that the primer composition does not have to dry prior to application of the electrostatically applied paint thereby increasing the efficiency of the process. Thus, the present invention can be used in-line during pultrusion/extrusion of the substrates/articles which are to be electrostatically coated/painted.

The method according to the invention provides a tenaciously adhered electrostatic coating. Using the method of the present invention, substrates having a superior combination of strength and thermal resistant properties can be obtained.

The present invention finds particular utility for coating long, thin, extruded or pultruded profiles.

These and other aspects of the invention are described in the following detailed description of the invention or in the claims.

### BRIEF DESCRIPTION OF THE DRAWINGS

FIG. 1 is a schematic diagram illustrating one embodiment of an in-line pultrusion/electrostatic painting process according to the invention.

FIG. 2 is an off-line version similar to that shown in FIG. 1 wherein a drive mechanism carries a profile to primer treating and electrostatic coating stations according to the invention.

FIG. 3 is a schematic diagram illustrating another embodiment of an in-line pultrusion/electrostatic painting process according to the invention.

FIG. 4 is an off-line version similar to the in-line version shown in FIG. 3 including primer treating and electrostatic coating stations according to the invention.

FIG. 5 is a schematic diagram illustrating another embodiment of a pultrusion/electrostatic painting process according to the invention.

FIG. 6 is a schematic diagram illustrating another embodiment of a pultrusion/electrostatic painting process according to the invention.

### DETAILED DESCRIPTION OF THE INVENTION

While this invention may be embodied in many different forms, there shown in the drawings and described in detail herein specific preferred embodiments of the invention. This description is an exemplification of the principles of the invention and is not intended to limit the invention to the particular embodiments illustrated.

The present invention relates to an improved in-line method of providing conductivity to a substrate having little or no inherent conductivity by applying a primer comprising a halogen, halogen salt, halogen complex or mixture thereof, and electrostatically painting the substrate. The method finds particular utility for profiles formed using pultrusions/extrusion of materials that have little or no conductivity.

Examples of such materials include, for example, organic materials or composites thereof, fibers or composites thereof and poor metals or metalloids and alloys thereof.

Examples of poor metals include, but are not limited to, aluminum, gallium, indium, tin, thallium, lead, bismuth, and sometimes included are germanium, antimony and polonium.

In some embodiments, fiberglass is employed for forming the profiles according to the method disclosed herein. However, other fibers may also be employed in the method of forming and electrostatically coating the profiles disclosed herein. Examples of suitable fiber materials which may be employed herein include, but are not limited to, polyamide (nylon) fiber such as aramid fiber (a type of nylon sold under the trade name KEVLAR® available from DuPont de Nemours in Wilmington, Del.), polyolefins such as polyethylene and polypropylene fiber, polyester fiber, liquid crystal polymer (LCP) fibers such as VECTRAN® LCP fiber available from Kuraray America in New York, N.Y., glass fiber (S-2 and E), quartz fiber, graphite fiber, and so forth. The fibers are typically commercially available as a yarn or roving, i.e., a twisted “bundle” or untwisted “bundle”, respectively, of individual filaments, on a spool. Such fibers can then be processed into profiles via pultrusion.

Other materials such as aluminum or vinyl which are not in fiber form may suitably be processed into profiles via extrusion.

The present invention finds utility for treating and electrostatically coating virtually any profile formed from polymer materials which have little or no conductivity.

The primer compositions suitable for use herein are disclosed in commonly assigned U.S. Pat. Nos. 6,620,463 and 6,855,429, each of which is incorporated by reference herein, and include those compositions including at least one halogen, halogen salt, halogen complex or mixture thereof. Such compositions are suitably applied using a carrier.

More specifically, the primer composition may include halophors of nonionic surfactants, halophors of amphoteric surfactants, iodophors, chlorophors and bromophors of anionic surfactants, halophors of glycol ether or polyvinylpyrrolidone, hypohalites, hypohalates, perhalates, iodine, chlorine, bromine, fluorine, and mixtures thereof. These types of primer compositions are also disclosed in commonly assigned U.S. Pat. Nos. 6,620,463 and 6,855,429.

In some embodiments, iodine or complexed iodine (iodophors) are employed in the primer composition. Examples of complexed iodine include, but are not limited to, polyethoxylated nonylphenol iodine complex and polyethoxylated fatty alcohol iodine complex and mixtures thereof.

Suitably the primer composition is applied to the profiles with a liquid carrier solvent. Examples of suitable carriers (also disclosed in U.S. Pat. Nos. 6,620,463 and 6,855,429) include, but are not limited to, water, alcohol such as ethanol, isopropanol and methanol, acetone, ethers such as diethyl ether, toluene, p-xylene, benzene, carbon disulfide, chloroform, carbon tetrachloride, glycerol, alkaline iodide solutions, and so forth, and mixtures thereof. Some carriers are more preferable than others due to the varying levels of toxicity or environmental concern, with water being a preferred solvent. Water in combination with another carrier, such as an alcohol, is also suitably used.

A benefit of employing such primer compositions is that it has been found that drying of the conductive primer composition prior to application of the electrostatically applied coating or paint is not necessary, although a drying step can be included if so desired. Elimination of drying, however, increases the efficiency of the manufacturing process and also reduces the amount of space required for manufacturing an article formed of a non-conductive substrate.

Application of the conductive primer composition also allows for selective painting of a substrate because the electrostatically applied paint does not adhere to those surfaces to which no conductive primer composition has been applied. Selective application can be more economically efficient by using less material on surface areas where no paint is necessary.

The present invention finds utility for electrostatically painting profiles formed during pultrusion and extrusion processes. In a typical pultrusion process wherein a fiber-reinforced profile is being formed, fibers are pulled from a fiber source such as a fiber creel (rack) or spool through a what is referred to in the art as a resin bath which includes a thermoplastic composition, or a thermoset or curable composition, and then pulled through a heated die to set or cure the thermoplastic or thermoset composition and the fibers to form a product that has the general form of the die. The cured product may then be cut to a desired length. The fibers that are pulled through the resin bath may be individual fibers or part of a woven mat. The pultrusion process is well suited for the continuous production of products ranging from simple round bars to more complex panels. For a discussion of pultrusion of fiber-reinforced plastics, see, for example, U.S. Pat. Nos. 6,881,288, 6,872,273, 6,314,704, 6,106,944, 6,007,656, 5,989,376, 5,879,178, 5,585,155, and 4,938,823, each of which is incorporated by reference herein in its entirety. See also U.S. Pat. No. 5,866,051 discussing extrusion of fiber-reinforced plastics, the entire content of which is incorporated by reference herein.

The present invention combines an electrostatic coating method in-line with such a pultrusion/extrusion process.

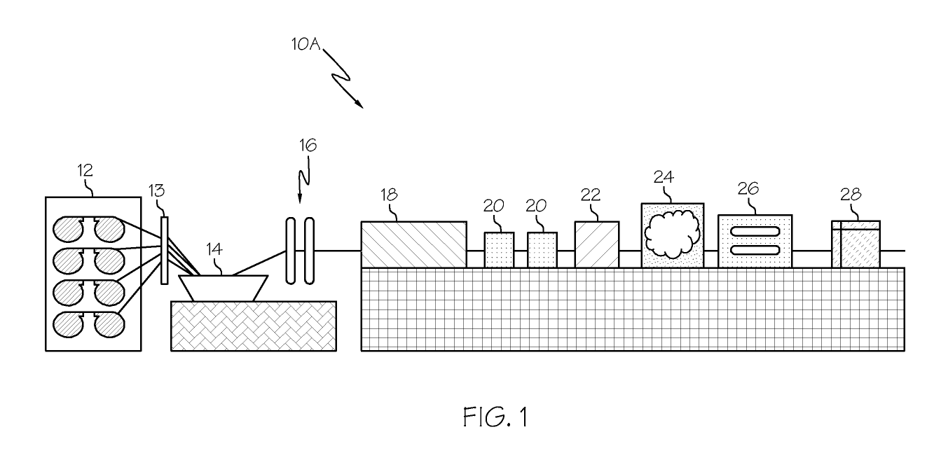

Turning now to the figures, FIG. 1 illustrates generally at 10(A), one embodiment of a process according to the invention wherein profiles are formed of materials having little or no conductivity via pultrusion/extrusion processes and are treated with a primer composition and electrostatically painted in-line. In a first step, a fiber source 12 provides a feed of fiber. A fiber source may also include one or more fiber supplies. Examples of suitable fiber supplies include, but are not limited to, a fiber spool, a fiber creel, a vapor deposition chamber, or other type of fiber supply. The fiber may be fed under tension. It has been found that feeding fiber under tension can provide pre-stress to the fiber which in turn may enhance one or more features of the fiber such as strengthening of the fiber. The fiber source 12 shown in FIG. 1 is a fiber creel. However, the present invention is not limited to this type of fiber source.

From the fiber source 12, the fiber is fed to resin source 14. Prior to the resin source 14, the fibers may be gathered together using a pre-die 13. Resin source 14 may include any suitable resin composition.

The resin composition may include thermoset materials, thermoplastic materials, as well as mixtures thereof. Suitable thermoset materials include polymers, oligomers and monomers. Examples include, but are not limited to, polyesters, particularly unsaturated polyesters, urethanes, phenolic resins, epoxies, bismaleimides including bismaleimides modified with epoxies, biscyanate and modifications thereof, vinyl ethers, vinyl esters, cashew nut shell resins, naphthalinic phenolic resins, epoxy modified phenolic resins, silicones, polyimides, urea formaldehydes, methylene dianiline, methyl pyrrolidone, (meth)acrylates, isocyanates, etc.

Examples of thermoplastic resins suitable for use herein include, but are not limited to, homopolymers, copolymers and terpolymers of butylene, ethylene and propylene including polypropylene, polyethylene, polystyrene, ethylene vinyl acetate copolymers, metallocene polyolefins (poly(α-olefins), etc.

Suitable fluoropolymers include, but are not limited to, polytetrafluoroethylene, fluoro ethylene propylene, polyhexafluoropropylene, polyhexafluoroethylene, perfluoro(methyl vinyl)ether, perfluoro(propyl vinyl)ether, ethylene tetrafluoroethylene, pefluoroalkoxy polymer, and so forth.

Other thermoplastic polymers include, but are not limited to, poly(meth)acrylates, polyvinylchlorides, polyvinylbutyrate, polyamides, polyether-block-amides (PEBAX®), polyetheretherketone (PEEK), polyesters, copolyesters, polyetheresters, polyruethanes, polycarbonates, polyketones, polyureas, and so forth. Polystyrene and block copolymer elastomers of styrene (S), isoprene (I), butadiene (B), ethylene/butylene (EB), ethylene/propylene (EP), isobutylene (IB) including SIS, SBS, SEBS, SEPS SIBS, and so forth.

Natural resins may also be employed in the resin bath. Natural resins include, but are not limited to, terpenes, rosins, balsams, and so forth. Such resins may be modified such as with phenolics, for example.

The above lists are intended for illustrative purposes only, and not as a limitation on the scope of the present invention. The invention is not limited by which thermoplastic or thermoset composition is selected for use. Suitably, the thermoset or thermoplastic composition is selected so as to provide increased strength to the fibers.

Other suitable additives for thermoplastics and thermosets may be added to the composition. For example, thermoplastics may include, in addition to at least one polymer, a tackifying resin, wax, oil, and other additives such as antioxidants, colorants, fluorescing agents, etc. as well as mixtures thereof. For thermoset materials, suitable additives may include, for example, polymerization initiators, chain extenders, catalysts, and so forth, as well as mixtures thereof. Such additives are well known in the art.

From the resin bath 14, the fibers are passed through a forming guide system 16 which, for example, can may include one or more of a plurality of machined plates, sheet metal guides or like, which consolidates the resin impregnated fibers into the approximate shape of the desired pultruded article. In the embodiment shown in FIG. 1, the consolidated mass of resin impregnated fibers emerging from the forming guide system 16 is pulled through a temperature controllable pultrusion die 18 which is capable of undergoing rapid temperature cycling and passes to a gripping/pulling means 20.

In a typical pultrusion process, once the now cured resin impregnated fiber has passed through the pulling means 20 to form long length profiles which are then further cut to the desired length by a cutting means such as a circular saw, band saw or the like.

However, in the process according to the present invention, the pultrusion process including stations 12, 13, 14, 16, 18 and 20, has been combined with an in-line electrostatic painting process. From pulling means 20, the resin impregnated fiber is passed to a primer application station 22.

Suitably, the primer composition is in a carrier liquid or solvent for application to the profiles. Examples of suitable carriers include, but are not limited to, water, alcohol such as ethanol, isopropanol and methanol, acetone, ethers such as diethyl ether, toluene, p-xylene, benzene, carbon disulfide, chloroform, carbon tetrachloride, glycerol, alkaline iodide solutions, and so forth, and mixtures thereof. Some carriers are more preferable than others due to the varying levels of toxicity or environmental concern, with water being a preferred solvent. Water in combination with another carrier, such as an alcohol, is also suitably used. Excess primer may be removed with either mechanical wipers or air knives to leave a thin film. Other means of controlling the amount of primer may also be used.

Application of the primer may be accomplished using any suitable method known in the art such as by running the composite fiber through a bath, spray or waterfall. Excess primer can be removed using any suitable method such as wipers or air knives to leave only a thin film of the primer on the profile.

The primed fiber composite profile, while still wet, can be advanced to the electrostatic painting station 24. Any suitable conventional electrostatic or powder painting equipment may be employed such as conventional paint guns, or alternatively, the profiles may be run through a fluidized bed of powder paint. Nordson and Wagner manufacture powder coating equipment. Specific examples include the Nordson 2001 powder coating system and the Wagner EPG 2007 powder coating system. Using powder painting methods such as these, an electrostatic charge may first be applied to the surface of the substrate or article after treatment with the primer composition. Typically, a negative charge is applied to the treated surface. An opposite charge may also be applied to the coating composition used in the electrostatic coating process, and then paint is electrostatically applied. Other means of paint application are well known and may also be employed herein.

The powder painted fiber composite profile may then be advanced through baking station 26 including convection, infared or UV baking source, for example, and then may be cut to size at cutting station 28 using any suitable method such as circular saw, band saw or the like.

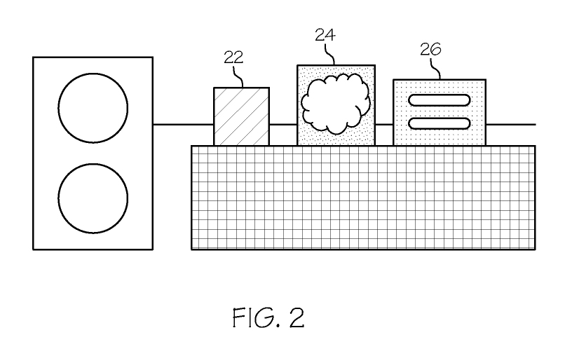

FIG. 2 is an offline version wherein a drive mechanism is employed to move the profile to a primer treatment station 22, an electrostatic coating station 24 a baking station 26.

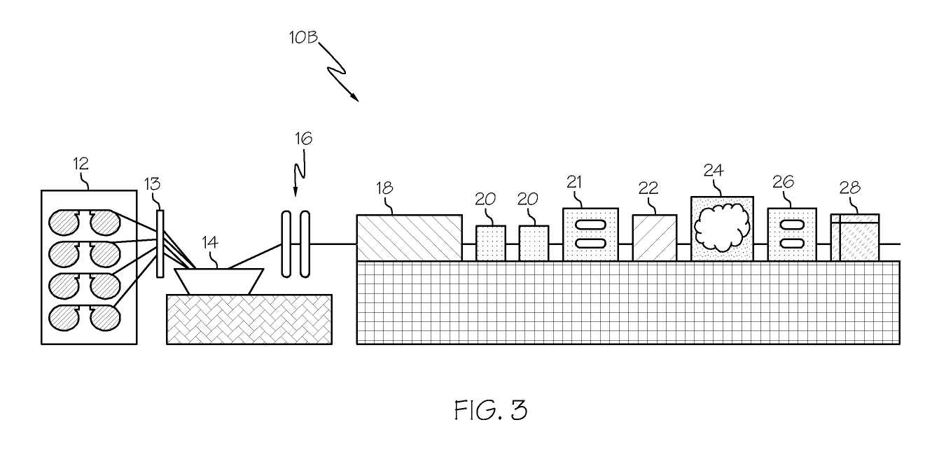

FIG. 3 is a schematic diagram illustrating another embodiment of a pultrusion/electrostatic painting process 10(B) according to the invention. This process is similar to the embodiment shown in FIG. 1, with the exception that the process includes an additional outgas bake station 21. This additional step is advantageous in that it preheats the substrate prior to application of the primer composition to facilitate outgasing of the surface. While this step provides advantages, it is optional for many pultrusions.

Styrene chemistry based pultrusions can tend to lose non-bonded styrene molecules at temperatures when most powder paints are turning to liquid and subsequently cured by crosslinking. This can result in small bubbles or craters to occur on the finished painted surface. To avoid this, the pultrusion is preheated from 25° F. to 50° F. higher than the temperature at which the powder paint is cured. This drives off the non-bonded styrene molecules prior to powder coating and thereby eliminates any defects that may occur.

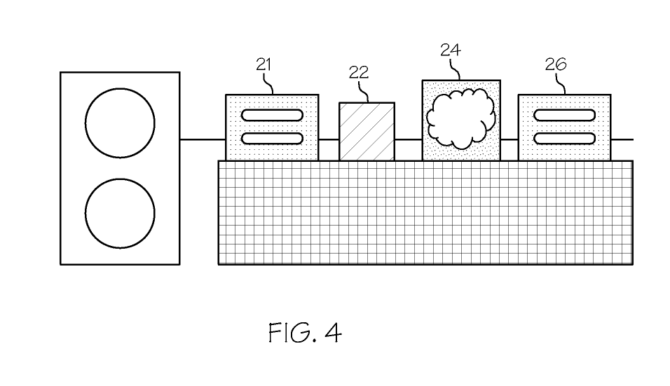

FIG. 4 is an off-line version similar to that shown in FIG. 3 wherein a drive mechanism can transport profiles to stations 21, 22, 24 and 26 for application of the conductive primer composition and electrostatic coating/painting.

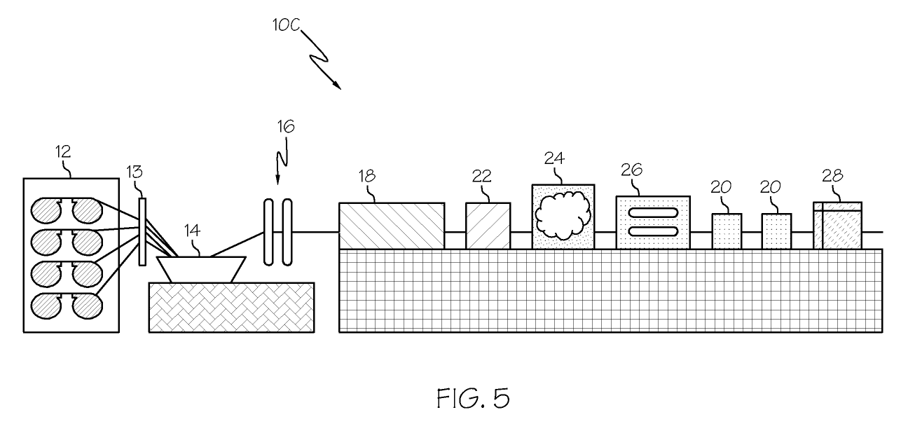

FIG. 5 is a schematic diagram illustrating another embodiment of a pultrusion/electrostatic painting process 10(C) according to the invention. This process is also similar to the embodiment shown in FIG. 1 with the exception that the puller station 20 has been alternatively placed after primer application 22, powder painting 24 and baking 26 rather than prior to these steps as shown in FIG. 1.

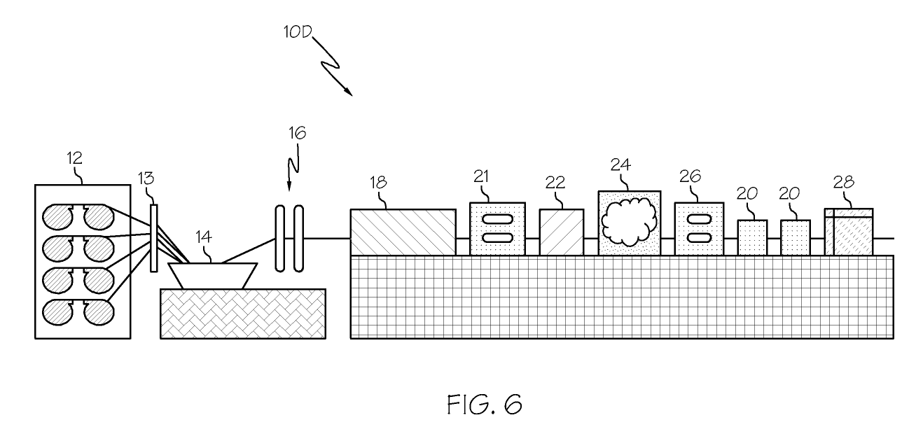

FIG. 6 is a schematic diagram illustrating another embodiment of a pultrusion/electrostatic painting process 10(D) according to the invention. This process employs the additional outgasing station 21 as shown in FIG. 2 and has the puller station 20 following the primer application 22, powder painting 24 and baking 26 stations as shown in FIG. 5. Again, as discussed with respect to FIG. 3 above, while this step provides advantages, it is optional for many pultrusions.

The present invention is particularly suitable for long, thin, extruded or pultruded profiles. The profiles formed according to the invention can be solid or hollow. They can have a variety of shapes and be used for construction assemblies such as windows, doors and door frames, particularly aluminum, fiberglass and vinyl profiles. The present invention can also be employed on thermo plastic extrusions that are using higher heat deflecting materials such as nylon, polyethylene terephthalate (PET), polycarbonate, polyamide-imide such as those available from Solvay Advanced Polymers under the tradename of TORLON®, etc. This list is intended for illustrative purposes only and not as a limitation on the scope of the present invention. Those of ordinary skill in the art would understand the selection of materials having high heat deflection temperatures.

The above disclosure is intended to be illustrative and not exhaustive. This description will suggest many variations and alternatives to one of ordinary skill in the art. All these alternatives and variations are intended to be included within the scope of the attached claims. Those familiar with the art may recognize other equivalents to the specific embodiments described herein which equivalents are also intended to be encompassed by the claims attached hereto.

1. A method for electrostatically coating a profile in-line formed by pultrusion or extrusion, the method comprising the steps of:
providing at least one material selected from the group consisting of organic materials and composites thereof, fibers and composites thereof and poor metals and alloys thereof;
forming a profile of said at least one material;
applying a conductive primer composition to at least a portion of said profile, the primer composition comprising at least one member selected from the group consisting of halogens, halogen salts, halogen complexes and mixtures thereof in a liquid carrier; and
applying an electrostatic coating to said at least a portion of said profile.

2. The method of claim 1 further comprising the step of applying a thermoset composition, a thermoplastic composition or mixture thereof to said material prior to forming said profile.

3. The method of claim 2 comprising applying a thermoset composition to said material prior to forming said profile.

4. The method of claim 3 further comprising the step of curing said thermoset material with a source or energy.

5. The method of claim 1 wherein said conductive primer composition is applied to said profile by a method selected from the group consisting of bath, spray and waterfall.

6. The method of claim 1 wherein said electrostatic coating is applied to said profile by spraying or by passing said profile through a fluidized bed.

7. The method of claim 1 wherein said electrostatic coating is applied to said profile before said primer composition dries.

8. The method of claim 1 further comprising the steps of:
baking said profile after applying said electrostatic coating to said profile; and
cutting said profile to a desired length.

9. The method of claim 1 wherein said profile comprises fiberglass.

10. The method of claim 9 wherein said profile is formed by pultrusion.

11. The method of claim 10 further comprising the steps of:
providing a fiber source;
applying a composition which comprises at least one member selected from the group consisting of thermoplastic materials, thermoset materials and mixtures thereof to said fiber source to form a composite; and
pultruding said composite through a die.

12. The method of claim 1 wherein said material is aluminum or vinyl.

13. The method of claim 12 wherein said profile is formed by extrusion.

14. The method of claim 1 wherein said conductive primer composition comprises at least one halogen complex which is an iodophor or a mixture of iodophors.

15. A method for electrostatically coating a profile off-line formed by pultrusion or extrusion, the method comprising the steps of:
automatically transporting said profile from a pultruder or an extruder to a primer treating station;
applying a conductive primer composition to at least a portion of said profile, the primer composition comprising at least one member selected from the group consisting of halogens, halogen salts, halogen complexes and mixtures thereof in a carrier; and
applying an electrostatic coating to said at least a portion of said profile.

16. The method of claim 15 further comprising the step of:
outgasing said profile prior to applying said conductive primer composition to said profile.

17. The method of claim 15 wherein said primer composition comprises at least one halogen complex is an iodophor.

18. The method of claim 15 further comprising the step of:
baking said profile after applying said electrostatic coating to said profile.

19. A method of making a pultruded fiber-reinforced polymer material, the method comprising the steps of:
providing a fiber source;
exposing said fiber source to a thermoset composition, a thermoplastic composition of mixture thereof to form a composite material;
pultruding the composite through a die using pullers to form a profile;
applying a conductive primer composition comprising at least one member selected from the group consisting of halogens, halogen salts, halogen complexes and mixtures thereof in a carrier to the profile; and
electrostatically coating the profile.

20. The method of claim 19 further comprising the step of applying a heat source to the composite material.

21. The method of claim 20 wherein said fiber source is exposed to a thermoset composition to form a composite material.

22. The method of claim 19 further comprising the step of:
outgasing said profile prior to applying said conductive primer composition.

23. The method of claim 19 further comprising the steps of:
baking said profile after application of said electrostatic coating; and
cutting said profile to a desire length.

24. The method of claim 19 wherein said conductive primer composition comprises at least one halogen complex which is an iodophor or a mixture of iodophors.
